(19) United States
(12) Patent Application Publication
(10) Pub. No.: US 2017/0010932 A1
(43) Pub. Date: Jan. 12, 2017

(54) COMMUNICATION SYSTEM AND COMMUNICATION METHOD

(71) Applicant: KABUSHIKI KAISHA TOSHIBA, Tokyo (JP)

(72) Inventors: Hiroyuki INAMURA, Hachioji (JP); Masaomi YOSHIKAWA, Inagi (JP); Shunya MARUCHI, Itabashi (JP)

(73) Assignee: Kabushiki Kaisha Toshiba, Tokyo (JP)

(21) Appl. No.: 15/115,524

(22) PCT Filed: Jul. 31, 2014
(86) PCT No.: PCT/JP2014/070277

§ 371 Date: Jul. 29, 2016

(30) Foreign Application Priority Data
Jan. 31, 2014 (JP) 2014-017242

(51) Int. Cl. G06F 11/07

(52) U.S. Cl. CPC G06F 11/079; G06F 11/0709; G06F 11/0751; H04W 84/18

(57) ABSTRACT

A communication system includes a plurality of communication devices that transmits shared data in turn through wireless communication. Each of the communication devices includes a shared memory, a transmission processor, a reception processor, and a data comparator. The shared memory is capable of storing shared data for each of the communication devices. The transmission processor transmits the shared data of the communication device stored in the shared memory to a second communication device as another communication device. The reception processor monitors data as the shared data received by the second communication device from the communication device and transferred to a third communication device as another communication device other than the second communication device, and receives the data as monitored data. The data comparator compares the received monitored data with the data previously transmitted to the second communication device.

### FIELD

Embodiments of the present invention relate to a communication system and a communication method.

### BACKGROUND

Conventionally, known have been a distribution-type processing system including devices such as computers for individually performing processing in synchronization with one another, and a control system including control devices to operate in synchronization with one another in a plant or the like. In these systems, the devices transfer predetermined data in turn via wireless communication paths for sharing in some cases.

### CITATION LIST

### Patent Literature

Patent Literature 1: Japanese Patent Application Laid-open No. 5-347

Patent Literature Japanese Patent Application Laid open No. 11-127479

### SUMMARY OF THE INVENTION

### Problem to be Solved by the Invention

In such conventional technique, data error is likely to occur due to interference or the like from an ambient environment. In such a case, erroneous data is transferred to or no data reaches subsequent devices, causing data inconsistency among the devices. For this reason, it is desirable to avoid system failure resulting from data anomaly due to wireless transmission error in wireless communication system for the purpose of improving system reliability.

### Means for Solving Problem

A communication system according to an embodiment is a communication system comprising a plurality of communication devices that transmits shared data in turn through wireless communication. Each of the communication devices comprises a shared memory that is capable of storing shared data for each of the communication devices; a transmission processor that transmits the shared data of an own communication device stored in the shared memory to a second communication device as another communication device; a reception processor that monitors data as the shared data received by the second communication device from the communication device and transferred to a third communication device as another communication device other than the second communication device, and that receives the data as monitored data; and a data comparator that compares the received monitored data with the data previously transmitted to the second communication device.

### BRIEF DESCRIPTION OF DRAWINGS

FIG. 1 is a diagram illustrating the network configuration of a communication system according to a first embodiment.

FIG. 2 is a diagram illustrating data transmission and reception operations by a scan transmission system according to the present embodiment.

FIG. 3 is a block diagram illustrating the functional configuration of a communication device in the first embodiment.

FIG. 4 is a diagram illustrating an example of the structure of transmission data and reception data in the first embodiment.

FIG. 5 is a flowchart of an example of communication process in the first embodiment.

FIG. 6 is a time chart illustrating an example of data transmission and reception operations in the first embodiment.

FIG. 7 is a flowchart of an example of data validity determination process in the first embodiment.

FIG. 8 is a block diagram illustrating the functional configuration of a communication device according to a second embodiment.

FIG. 9 is a flowchart of an example of communication process in the second embodiment.

FIG. 10 is a block diagram illustrating the functional configuration of a communication device according to a third embodiment.

FIG. 11 is a diagram illustrating an example of the data structure of an anomaly notifying message in the third embodiment.

FIG. 12 is a flowchart of an example of communication process in the third embodiment.

FIG. 13 is a time chart illustrating an example of data transmission and reception operations in the third embodiment.

FIG. 14 is a block diagram illustrating the functional configuration of a communication device according to a fourth embodiment.

FIG. 15 is a flowchart of an example of communication process in the fourth embodiment.

FIG. 16 is a time chart illustrating an example of data transmission and reception operations in the fourth embodiment.

FIG. 17 is a time chart illustrating an example of data transmission and reception operations according to a fifth embodiment.

### DETAILED DESCRIPTION

Hereinafter, embodiments will be described with reference to the accompanying drawings.

### First Embodiment

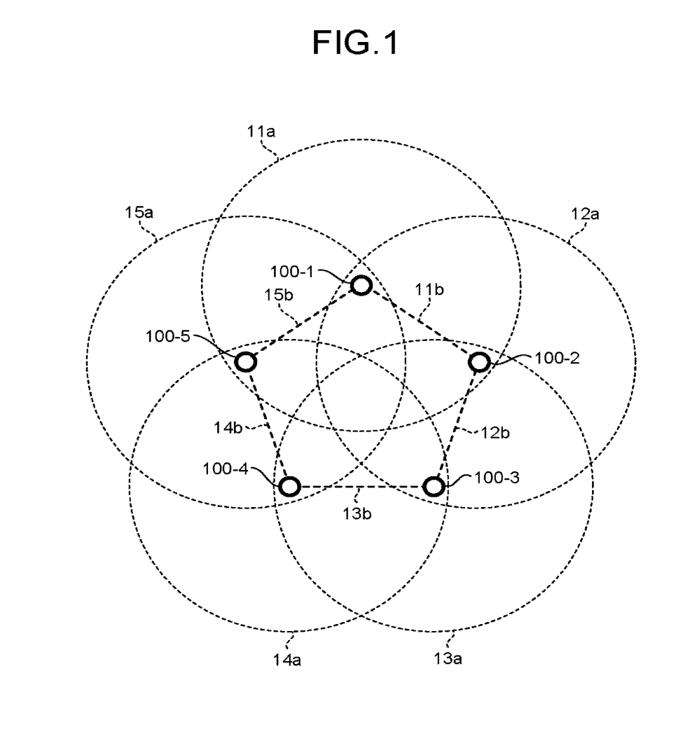

FIG. 1 is a diagram illustrating the network configuration of a communication system according to a first embodiment. As illustrated in FIG. 1, the communication system in the present embodiment is configured by five communication devices 100-1 to 100-5 each having a wireless communication function. The communication devices 100-1 to 100-5 can each wirelessly communicate with the other communication devices located in wireless communication regions 11a, 12a, 13a, 14a, and 15a, respectively. In the example of FIG. 1, the communication device 100-2 establishes respective wireless communication paths 11b and 12b to communicate with the communication device 100-1 and the communication device 100-3 located in its own wireless communication region 12a.

For example, the communication devices 100-1 to 100-5 in the present embodiment are applied to plant control devices such as programmable logic controllers (PLCs) for monitoring and controlling plants and facilities of various types such as water and sewerage treatment facilities, incineration facilities, seawater desalination facilities, and water treatment facilities. Their application should not be however limited thereto and they can be applied to any devices as long as multiple communication devices share data via wireless communication.

The communication devices 100-1 to 100-5 implement scan transmission of shared data via wireless communication. With the scan transmission system, the communication devices transmit a transmission right in turn. The one that has received the transmission right serves as a talker and transmits its own data from a shared memory thereof to another communication device at a fixed cycle, and upon receiving the data, another communication device updates the data of the corresponding communication device (talker) in the shared memory thereof.

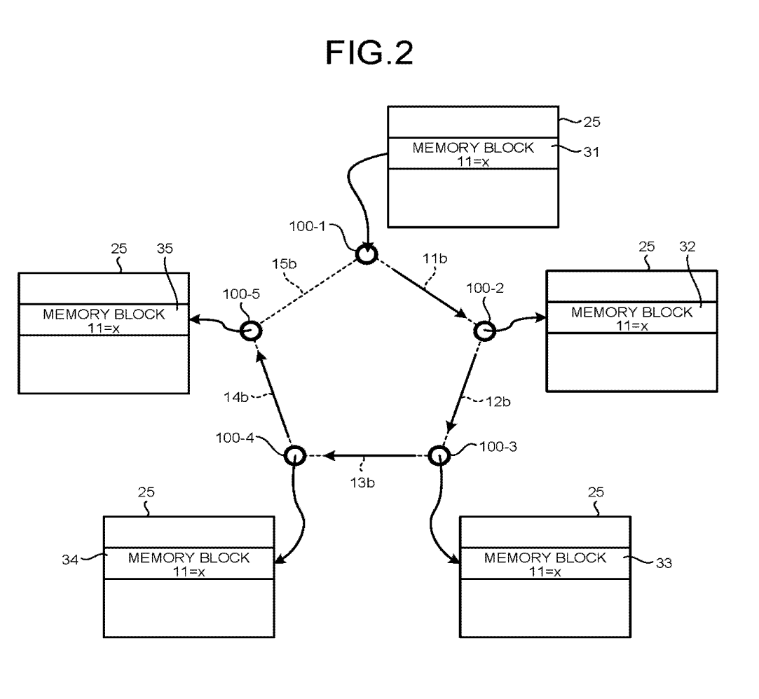

FIG. 2 is a diagram illustrating data transmission and reception operations by the scan transmission system in the present embodiment. In the example of FIG. 2, the communication device 100-1 transmits data to another communication device by the scan transmission system. Having acquired a transmission right, the communication device 100-1 reads and transmits data from a memory block 31 of a shared memory 25, the block assigned to the own device 100-1. The transmission data is transmitted to the adjacent communication device 100-2 through the wireless communication path 11b between the devices.

The communication device 100-2 stores the data received from the communication device 100-1 in a memory block 32 of its shared memory 25 assigned to the communication device 100-1. The communication device 100-2 further transfers the received data to the next communication device 100-3 through the wireless communication path 12b between the devices. The respective communication devices perform these operations in urn, so that the data of the communication device 100-1 is shared by the other communication devices 100-2 to 100-5. The transmission right is assigned to the communication devices 100-1 to 100-5 in turn and all of the communication devices 100-1 to 100-5 can thereby share the pieces of data of the other communication devices.

Hereinafter, the communication devices 100-1 to 100-5 may be collectively referred to as a communication device 100. The number of communication devices 100 is merely an example and should not be limited to five.

All of the communication devices 100 can share the pieces of data of the respective communication devices 100 by transferring the pieces of data in turn using the above-mentioned system. For example, when data error occurs due to wireless radio interference or the like in the wireless communication path 12b between the devices, erroneous data is transferred to or no data reaches the next communication devices 100, causing data inconsistency among the communication devices 100.

A conceivable countermeasure may be performing retransmission in accordance with a reception status of the receiving end using a transmission confirmation method defined by a protocol such as a transmission control protocol (TCP). The communication system, in which the communication devices 100 operate in synchronisation with one another at a fixed cycle, however needs at the receiving end anomaly detection and retransmission requesting process at the time of anomaly. Because of this, the communication system cannot maintain the fixed-cycle operation, which may result in system failure.

The present embodiment does not employ the countermeasure but avoids the system failure resulting from data anomaly due to wireless transmission error in order to improve the reliability of the fixed cycle operation. In the following the configurations thereof will be described.

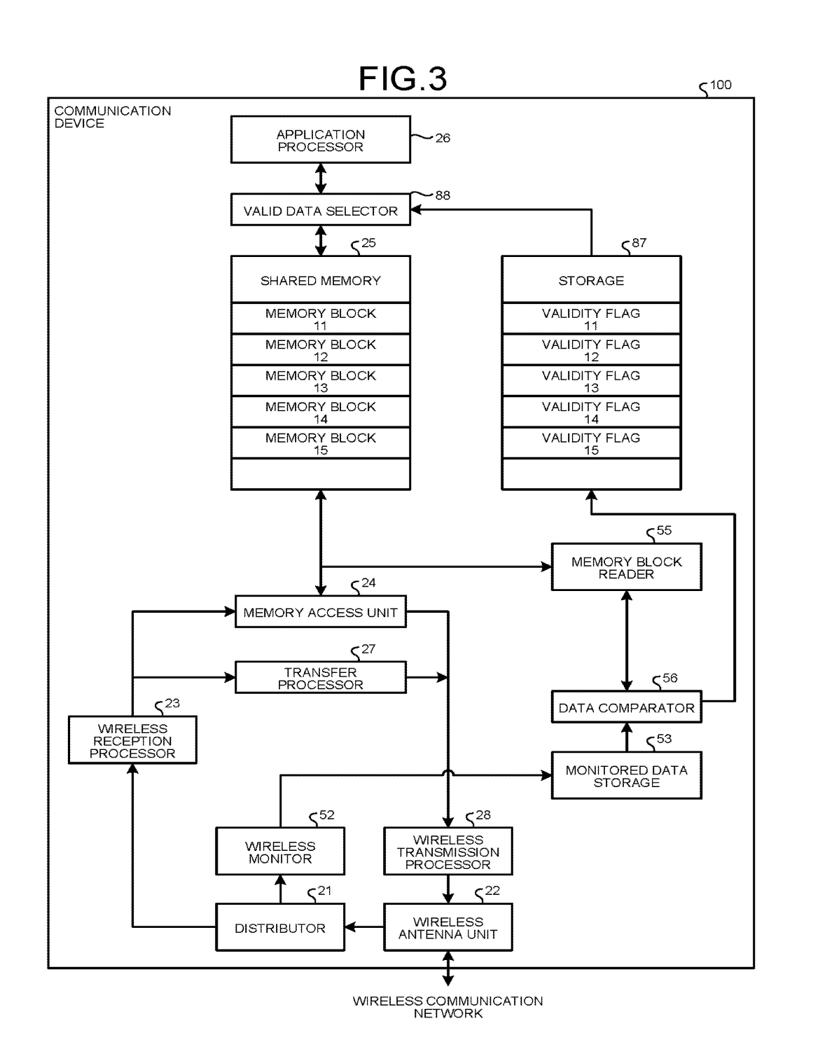

FIG. 3 is a block diagram illustrating the functional configuration of the communication device 100 in the first embodiment. As illustrated in FIG. 3, the communication devices 100 in the present hod rear each include an application processor 26, a valid data selector 88, the shared memory 25, a storage 87, a memory access unit 24, a memory block reader 55, a transfer processor 27, a wireless reception processor 3, a wireless monitor 52, a distributor 21, a wireless transmission processor 23, a wireless antenna unit 22, a data comparator 56, and monitored data storage 53. All of the communication devices 100-1 to 100-5 have the same functional configuration.

The shared memory 25 have five regions, memory blocks 11 t 15 which correspond to the communication devices 100-1 to 100-5, respectively. The memory blocks 11 to 1 store therein shared data of the communication devices 100-1 to 100-5, respectively.

The storage 87 stores therein validity flags indicating validity of the pieces of data stored in the memory blocks 11 to 15, respectively. The validity flags are set to “valid” at default and “invalid” is registered therein when the data comparator 56, which will be described later, detects anomaly in data. The storage 87 is a storage medium such as a memory or a hard disk drive (HDD).

The application processor 26 accesses and processes the data stored in he shared memory 25 uniquely to an application thereon. Upon receiving an access request for the data in the shared memory 25 from the application processor 26, the valid data selector 83 permits or inhibits data readout of the application processor 26, referring to the validity flag in the storage unit 87.

The wireless antenna unit 22 transmit and receives radio waves to and from a wireless communication network.

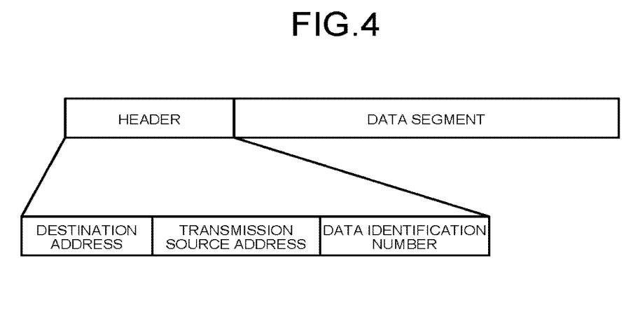

FIG. 4 is a diagram illustrating an example of the structure of transmission data and received data in the first embodiment. In the present embodiment, each of the transmission data and the received data includes a header and a data segment as illustrated in FIG. 4.

The data segment contains data contents. The header contains a destination address, a transmission source address, and a data identification number as illustrated in FIG. 4. The data identification number is a number for identifying the communication device 100 to which data in the data segment corresponds, and indicates the memory block number. The data identification number should not be limited thereto and can be arbitrarily set as long as it can identify the memory block.

Returning to FIG. 3, the distributor 21 refers to the destination address in the header of the received data based on the radio waves received by the wireless antenna unit 22 to determine whether the destination address matches the address of the communication device to which it belongs (the own device). When the destination address of the received data designates the address of the communication device (the own device), the distributor 21 sends the received data to the wireless reception processor 23. On the other hand, when the destination address of the received data designates the address of another communication device, the distributor 21 sends the received data to the wireless monitor 52.

The wireless reception processor receives the received data from the distributor 21, analyzes the header of the received data, and sends it to the memory access unit 24 and the transfer processor 27.

The memory access unit 24 stores the data in the data segment of the received data in the memory block of the shared memory 25 indicated by the data identification number in the data segment, that is, the memory block corresponding to another communication device 100 that has generated the data. The memory access unit 24 reads the data from the memory block of the shared memory 25 corresponding to the communication device to which it belongs and sends the data to the wireless transmission processor

The transfer processor 27 receives the received data from the wireless reception processor 23 and sends the data in the data segment to the wireless transmission processor 28.

The wireless transmission processor 28 adds a header to the data received from the transfer processor 27 and the data received from the memory access unit 24 to generate transmission data. The wireless transmission processor 28 sets the address of the next communication device 100 to the destination address in the header and sets the address of the communication device to which it belongs (the own device) to the transmission source address. When receiving the data from the memory access unit 24, the wireless transmission processor 28 sets the memory block number of the corresponding communication device (the own device) the data identification number in the header. When receiving the data from the transfer processor 27, the wireless transmission processor 28 does not change the data identification number set in header of the received data. The wireless transmission processor 28 then transmits the transmission data via the wireless antenna unit 22 through wireless communication.

The wireless monitor 52 monitors transmission data transmitted from the wireless transmission processor 28 to the next communication device 100. To be specific, the wireless monitor 52 acquires the transmission data transmitted from the next communication device 100 to the second next communication device 100. Such a monitoring by the wireless monitor 52 is referred to as a monitoring state. The transmission data acquired in the monitoring state and transmitted from the next communication device 100 to the second next communication device 100 is referred to as monitored data.

In this case, the distributor 21 distributes the transmission data to the wireless monitor 52 because the destination address thereof is not the address of the communication device to which it belongs (the own device). Then, the wireless monitor 52 stores the monitored data in the monitored data storage 53. The monitored data storage 53 is a storage medium such as a memory or an HDD.

The memory block reader 55 reads the data, which is the previous transmission data from the wireless transmission processor 28, from the memory block of the shared memory 25 corresponding to the corresponding communication (the own device) device.

The data comparator 56 compares data in the memory block corresponding to the corresponding communication device (the own device), the data which has been read by the memory block reader 55 as the transmission data, with the data in the data segment f the monitored data stored in the monitored data storage unit 53 to determine whether or not both of them are identical to each other. When both of them are not identical to each other, the data comparator 56 registers “invalid” in the validity flag corresponding to the memory block of the communication device that has transmitted the monitored data.

In the present embodiment, the data comparator 56 performs no registration to the validity flag when the monitored data and the data in the memory block corresponding to the corresponding communication device (the own device) are identical to each other because the validity flag is set to “valid” at default. The data comparator 56 may however be configured to set the corresponding validity flag to “valid” when they are identical to each other.

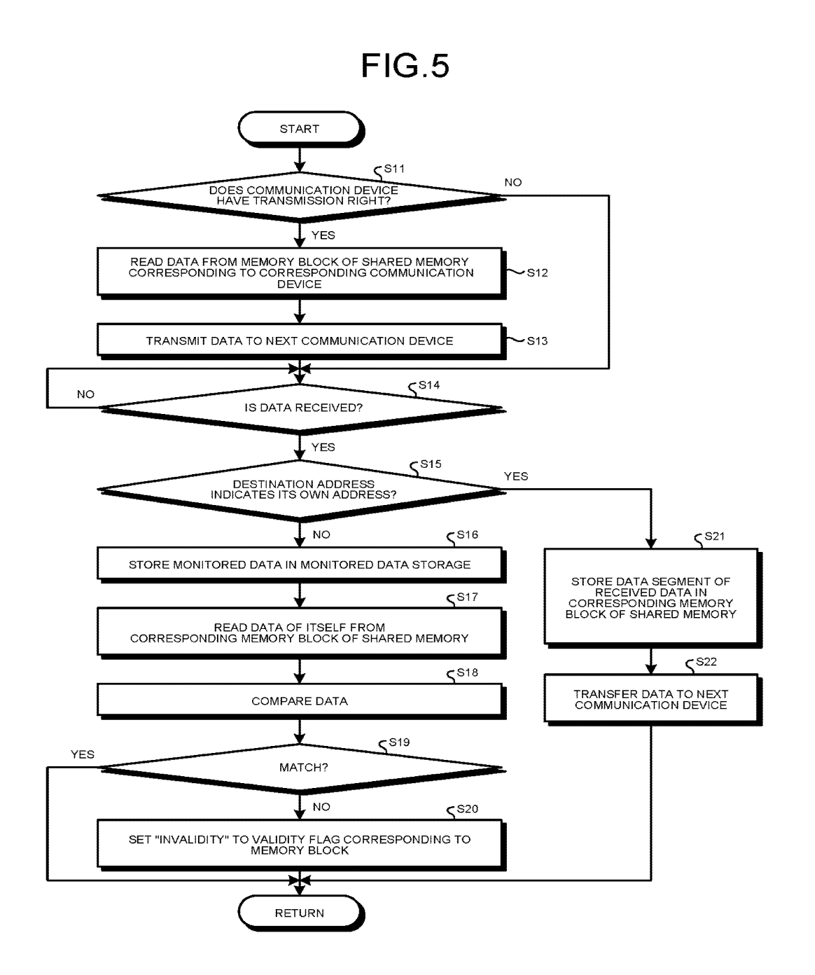

Next, the thus-configured communication processing according to the present embodiment will be described. FIG. 5 is a flowchart of an example of the communication process in the first embodiment.

First, the communication device 100 determines whether or not it currently has a transmission right by checking the setting in the memory or the like and so on (step S11). When the communication device 100 has the transmission right (Yes at step S11), the memory access unit 24 reads data of the corresponding communication device (the own device) from the memory block of the shared memory 25 corresponding to the corresponding communication device (the own device) (step S12). Then, the wireless transmission processor 28 adds the header to the read data of the corresponding communication device (the own device) and generates transmission data, and transmits the transmission data to the next communication device 100 (step S13).

Without the transmission right at step S11 (No at step S11), the communication device 100 does not perform the processing at steps S12 and 313.

The communication device 100 then waits for data reception (No at step S14). When the wireless antenna unit 22 receives data (Yes at step 314), the distributor 21 determines whether or not the destination address in the header of the received data designates the address of the communication device 100 (the own device) (step

When the destination address in the received data designates the address of the communication device 100 (the own device) (Yes at step S15), the distributor 21 sends the received data to the wireless reception processor 23 because the received data is transferred from another communication device 100. The wireless reception processor 23 delivers the data segment and the data identification number in the header of the received data to the memory access unit 24. The memory access unit 24 stores the data in the data segment in the memory block indicated by the data identification number (step S21).

The wireless reception processor 23 sends the received data to the transfer processor 27 and the transfer processor 27 sends the data segment thereof to the wireless transmission processor 28. The wireless transmission processor 28 adds the header to the received data segment and generates transmission data, and transmits the transmission data to the next communication device 100 (step S22). In this manner, the reception data is transferred to the next communication device 100.

When the destination address in the reception data does not designate the address of the communication device 100 (the own device) at step 315 (No at step S15), the received data is the data (monitored data) acquired during the monitoring of the transmission data transmitted from the next communication device 100. The wireless monitor 52 receives the received monitored data from the distributor 21 for storage in the monitored data storage 53 (step S16).

The memory block reader 55 then reads out the previously transmitted data of the corresponding own device that has been transmitted immediately before from the memory block corresponding to its own device in the shared memory 25 (step S17). The data comparison unit 56 compares the data portion of the monitored data stored in the monitored data storage unit 53 with the data of its own device (step S18). Then, the data comparison unit 56 determines whether both of them are identical to each other (step 19). When they are identical to each other (Yes at step S19), the data comparison unit 56 determines that the subsequent communication device 100 further transfers the transmission data normally and finishes the processing.

On the other hand, when the data portion of the monitored data stored in the monitored data storage unit 53 and the data of its own device are not identical to each other at step S19 (No at step S19), the data comparison unit 56 determines that error has been mixed into the monitored data, that is, the transmission data transmitted from the subsequent communication device 100. Then, the data comparison unit 56 sets “invalid” to the validity flag corresponding to the memory block indicated by the data identification number in the header portion of the monitored data (step S20).

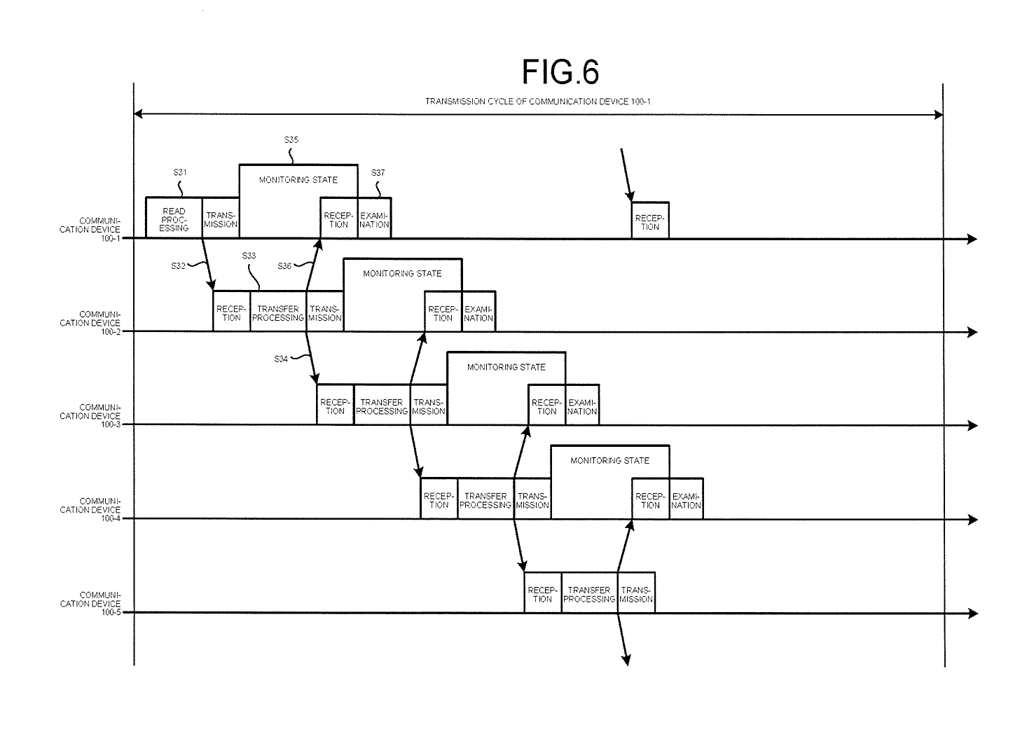

Next, an example of transmission and reception operations that are performed by executing the above-mentioned processing will be described. FIG. 6 is a time chart illustrating the example of the data transmission and reception operations in the first embodiment. When the communication device 100-1 acquires the transmission right, the communication device 100-1 acquires its own data from the shared memory 23 by reading processing (step S31) and transmits the data to the subsequent communication device 100-2 (step S32). The subsequent communication device 100-2 receives radio waves from the communication device 100-1 and acquires the data, and performs transfer processing (step S33). Then, the communication device 100-2 transmits the data to the subsequent communication device 100-3 (step 334).

The communication device 100-1 is made into the data monitoring state by the wireless monitoring unit 52 after the data transmission (step 335) and receives transmission data (monitored data) that the communication device 100-2 transfers to the communication device 100-3 (step S36).

The communication device 100-1 compares the data of its own device with the transmission data (monitored data) received in the monitoring state that the communication device 100-2 has transferred, and examines whether it has normally transmitted the data to the subsequent communication device 100-2 by comparing both of the pieces of data (step S37). In examination result is reflected to the validity flag as described above. The subsequent devices perform these pieces of processing in turn, for example, further data transmission from the subsequent communication device 100-2 to the following subsequent communication device 100-3.

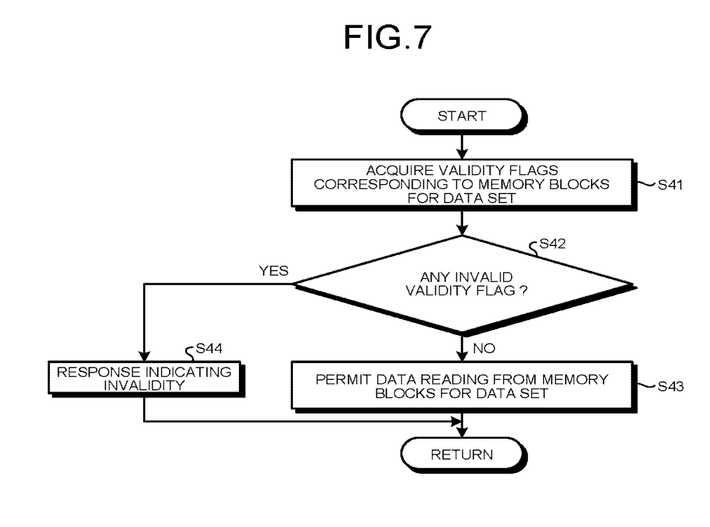

The following describes validity determination processing when the application processor 26 accesses the data in the shared memory 25 in a state where the examination result indicating whether the communication device 100-1 has normally transmitted the data to the subsequent communication device 100-2 has been reflected to the validity flag. FIG. 7 is a flowchart illustrating an example of procedures of the data validity determination processing in the first embodiment.

When the valid data selector 88 receives a request to read out the data in the shared memory 25 from the application processor 26, it acquires all the validity flags corresponding to the memory blocks for a data set (step S41). The data set is a unit of pieces of data to be processed. In the present embodiment, a unit collecting pieces of data in the memory block 11 to the memory block 15, that is, pieces of data corresponding to the communication devices 100-1 to 100-5 is set to one data set. The number of pieces of data per data set should not however be limited thereto.

The valid data selector 88 checks all of the acquired validity flags to determine whether there is any validity flag indicating invalidity (step S42). When all of the validity flags in the data set are valid, that is, indicate no invalidity (No at step S42), the valid data selector 88 permits the application processor 26 to read out the data from the memory blocks for the data set (step S43).

On the other hand, when any of the validity flags in the data set indicates invalidity at step S42 (Yes at step S42), the valid data selector 88 sends to the application processor 26 a response indicating the invalidity of data in the memory blocks for the data set(step S44) and does not permit the application processor 26 to read the data from the memory blocks for the data set. That is to say, in the present embodiment, the application processor 26 is configured to access the shared memory in unit of the data set, therefore, it is not allowed to access the shared memory for the entire data set if even a single piece of data in the data set contains error.

In the present embodiment, after the data transmission to the next communication device 100, the communication device 100 acquires the transmission data while further transferred to the second next communication device 100. Then, the communication device 100 compares the transmission data with its own data, determines the data as invalid when both of them are not identical to each other, and does not permit the application processor 26 to access the data. The present embodiment thus monitors the occurrence of data containing error due to the wireless transmission and excludes erroneous data, thereby avoiding system failure due to data error and improving the reliability of the fixed-cycle operation.

Although in the present embodiment, one data set is used as a unit in the data validity determination processing and the entire data set is excluded from the access target when any of the validity flags for the data in the data set indicates invalidity, the present embodiment should not be limited thereto. For example, the communication device 100 may be configured to use data in the data set as a unit and set the data as an access target when the validity flag for the data is valid.

### Second Embodiment

In the first embodiment, the data comparator compares the monitored data with the data (previously transmitted data) of the corresponding communication device (the own device) stored in the memory block of the shared memory 25. In a second embodiment, for transmitting transmission data to the next communication device, the communication device 500 temporarily stores communication data and compares the transmission data with the monitored data.

In the present embodiment, five communication devices 500-1, 500-2, 500-3, 500-4, and 500-5 can wirelessly communicate with one another as illustrated in FIG. 1. The communication devices 500-1, 500-2, 500-3, 500-4, and 500-5 may be collectively referred to as a communication device 500.

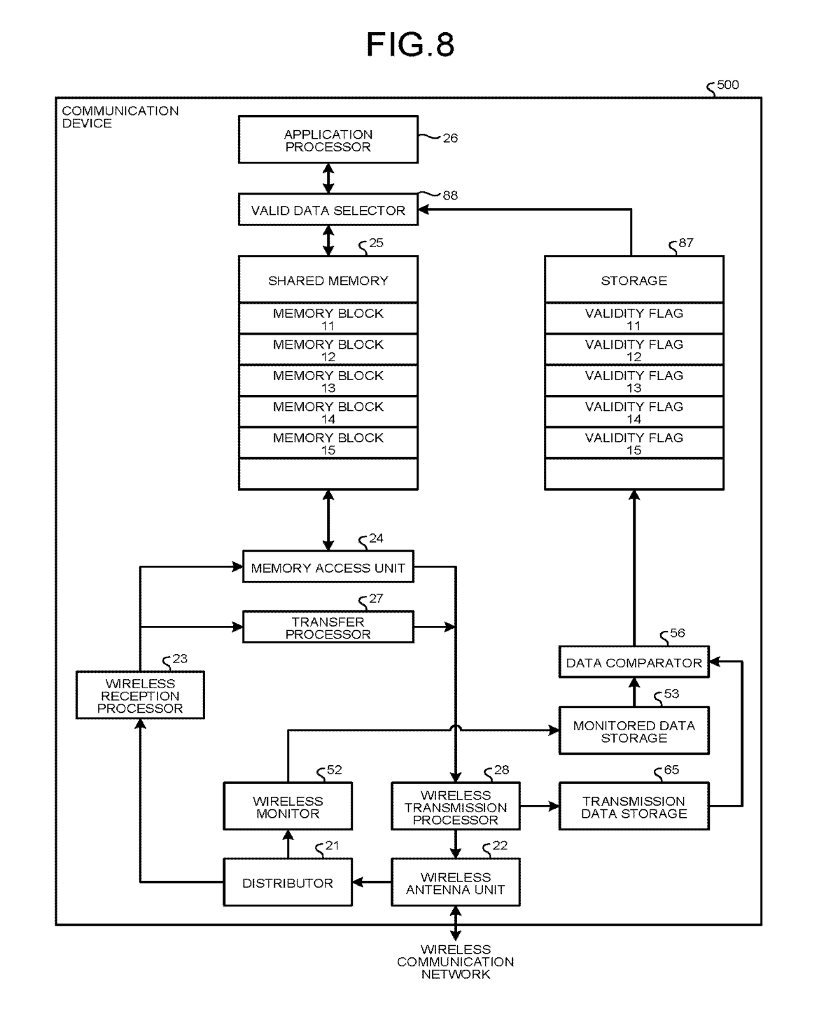

FIG. 8 is a block diagram illustrating the functional configuration of the communication device 500 in the second embodiment. As illustrated in FIG. 8, the communication device 500 in the present embodiment includes the application processor 26, the valid data selector 88, the shared memory 25, the storage 87, the memory access unit 24, the transfer processor 27, the wireless reception processor 23, the wireless monitor 52, the distributor 21, the wireless transmission processor 28, the wireless antenna unit 22, the data comparator 56, the monitored data storage 53, and a transmission data storage 65

The functions of the application processor 26, the valid data selector 88, the shared memory 25, the storage 87, the memory access unit 24, the transfer processor 27, the wireless reception processor 23, the wireless monitor 52, the distributor 21, the wireless antenna unit 22, and the monitored data storage 53 are the same as those in the first embodiment.

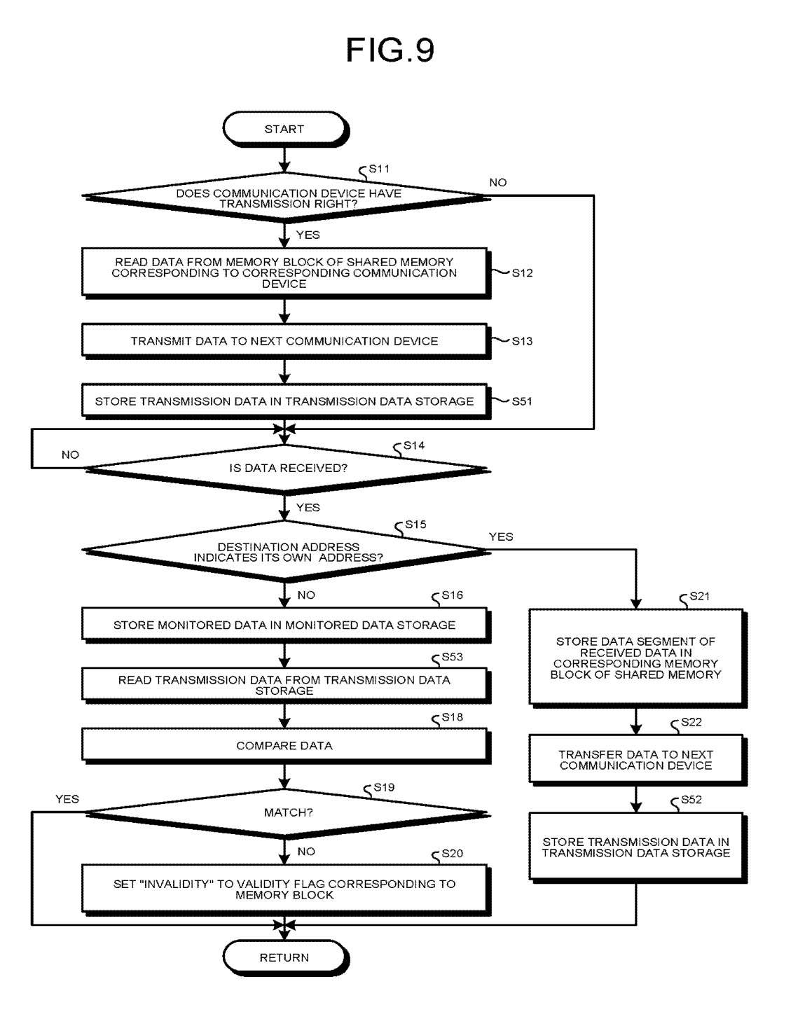

FIG. 9 is a flowchart of an example of communication process in the second embodiment.

In the present embodiment, when transmitting data of the corresponding communication device 500 (the own device) to the next communication device 500 (step S13) and transferring received data from the previous communication device 500 to the next communication device 500 (step S22), the wireless transmission processor 28 temporarily stores the transmitted transmission data in the transmission data storage 65 (steps S51 and S52).

For monitored-data examination, the data comparator 56 reads the temporarily stored transmission data from the transmission data storage 65 as the previously transmitted transmission data (step S53) and compares a data segment of the read transmission data with a data segment of the monitored data (step 18). The rest of the processing is performed in the same manner as that in the first embodiment.

In the present embodiment, for the transmission of transmission data to the next communication device, the communication data is temporarily stored and the transmission data is compared with the monitored data. The present embodiment thus provides the same effects as those in the first embodiment. In addition, the communication device not only can monitor and examine the transmission data corresponding to its own data but also can monitor and examine the transmission of transmission data from the next communication device 500, which is the data received from another communication device 500 and transferred to the next communication device 500, thereby avoiding system failure due to data error and improving the reliability of the fixed-cycle operation.

### Third Embodiment

In a third embodiment, when transmission data (monitored data) acquired from the next communication device and previous transmission data are not identical to each other, the communication device transmits an anomaly notifying message. When receiving the anomaly notifying message, the communication device identifies and invalidates anomalous data.

In the present embodiment, five communication devices 600-1, 600-2, 600-3, 600-4, and 600-5 can wirelessly communicate with one another as illustrated in FIG. 1. The communication devices 600-1, 600-2, 600-3, 600-4, and 600-5 may be collectively referred to as communication device 600.

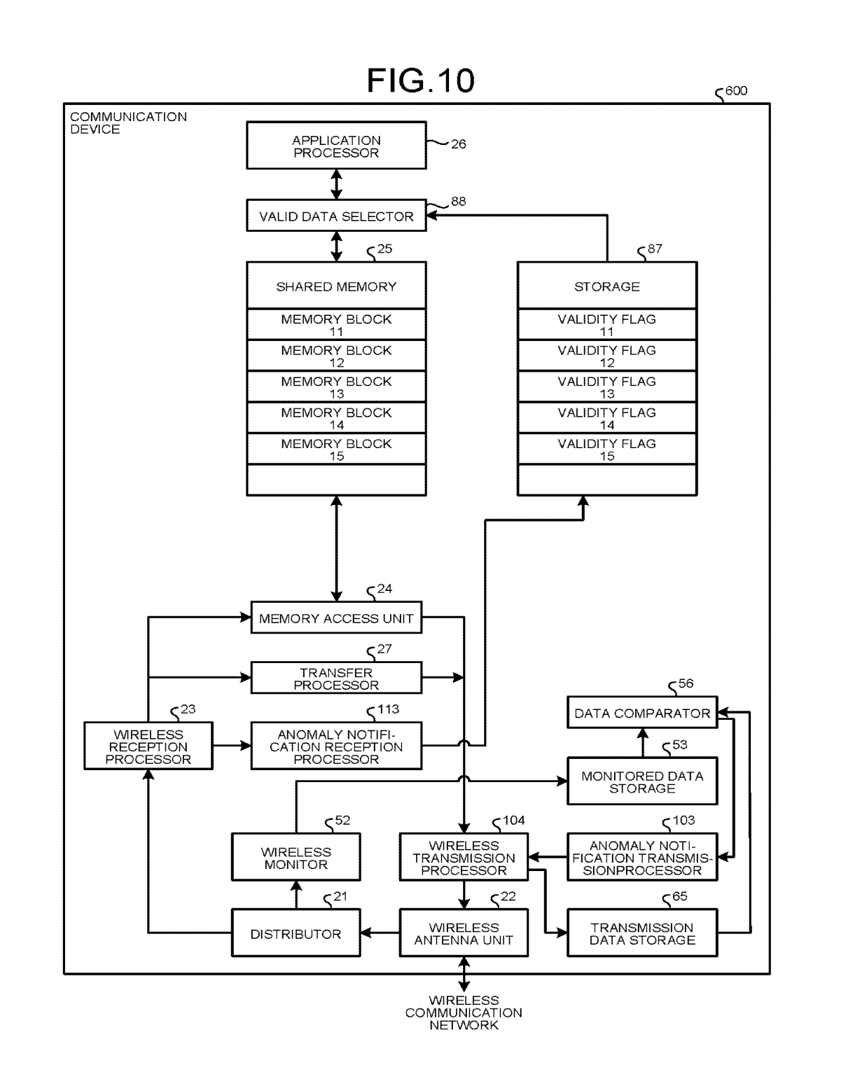

FIG. 10 is a block diagram illustrating the functional configuration of the communication device 600 according to the third embodiment. As illustrated in FIG. 10, the communication device 600 in the present embodiment includes application processor 26, the valid data selector 88, the shared memory 25, the storage 87, the memory access unit 24, the transfer processor 27, the wireless reception processor 23, an anomaly notification reception processor 113, an anomaly notification transmission processor 103, the wireless monitor 52, the distributor 21, a wireless transmission processor 101, the wireless antenna unit 22, the data comparator 56, the monitored data storage 53, and the transmission data storage 65.

The functions of the application processor 26, the valid data selector 88, the shared memory 25, the storage 87, the memory access unit 24, the transfer processor 27, the wireless reception processor 23, the wireless monitor 52, the distributor 21, the wireless antenna unit 22, the monitored data storage 53, and the transmission data storage 65 are the same as those in the second embodiment.

When the data comparator 56 determines that transmission data (monitored data) received from the next communication device 600 in the monitoring state is not identical to transmission data (that is, transmission data previously transmitted to the next communication device 600) temporarily stored in the transmission data storage 65, the anomaly notification transmission processor 103 determines the monitored data as non-normal and generates an anomaly notifying message. The anomaly notifying message is a message indicating that the monitored data, that is, the transmission data has anomaly.

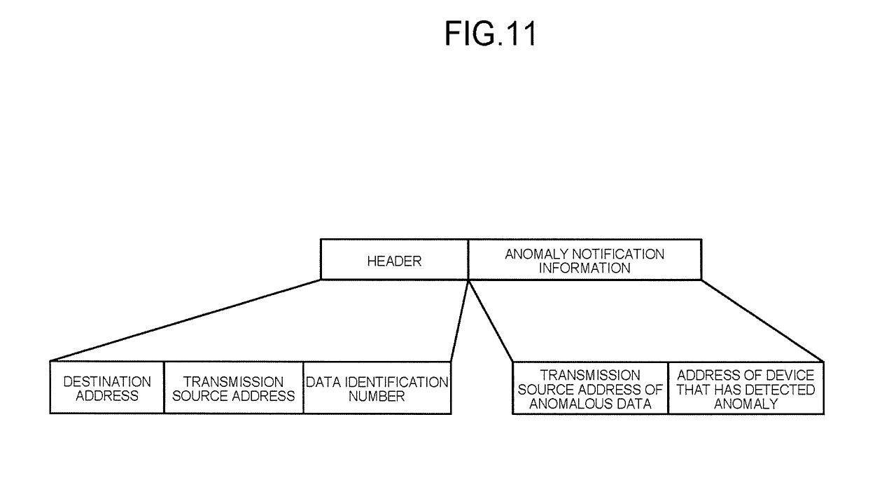

FIG. 11 is a diagram illustrating an example of the data structure of the anomaly notifying message in the third embodiment. As illustrated in FIG. 11, the anomaly notifying message includes a header and anomaly notification information. As in the first and second embodiments, the header contains a destination address, a transmission source address, and a data identification number. As illustrated in FIG. 11, the anomaly notification information contains a transmission source address of anomalous data and an address of the communication device that has detected anomaly. The structure of the anomaly notifying message is merely an example and should not be limited thereto. The anomaly notifying message may be configured to contain a different kind of information.

The anomaly notification transmission processor 103 sets, to the data identification number, the data identification number of the monitored data from which anomaly has been detected, sets the address of the communication device 600 having acquired the monitored data to the transmission source address of the anomalous data, and sets the address of the corresponding communication device (the own device) to the address of the device that has detected the anomaly. The anomaly notification transmission processor 103 transmits the generated anomaly notifying message to the next communication device 600 through the wireless transmission processor 104 and the wireless antenna unit 22. In this process, the wireless transmission processor 104 sets the next communication address to the destination address and sets the address of the corresponding communication device (the own device) to the transmission source address in the header in the same mariner as in the first embodiment. The anomaly notifying message is transmitted in turn from the next communication device 600 to the second and subsequent communication devices 600.

The anomaly notification reception process receives the anomaly notifying message from another communication device 600 through the wireless antenna unit 22, the distributor 21, and the wireless reception processor 23. The anomaly notification reception processor 113 identifies data in the memory block of the shared memory 25 corresponding to the communication device that has transmitted the monitored data, based on the data identification number contained in the anomaly notifying message. The anomaly notification reception processor 113 sets “invalid” to the validity flag corresponding to the identified memory block. The anomaly notifying message is not stored in the memory blocks of the shared memory 25.

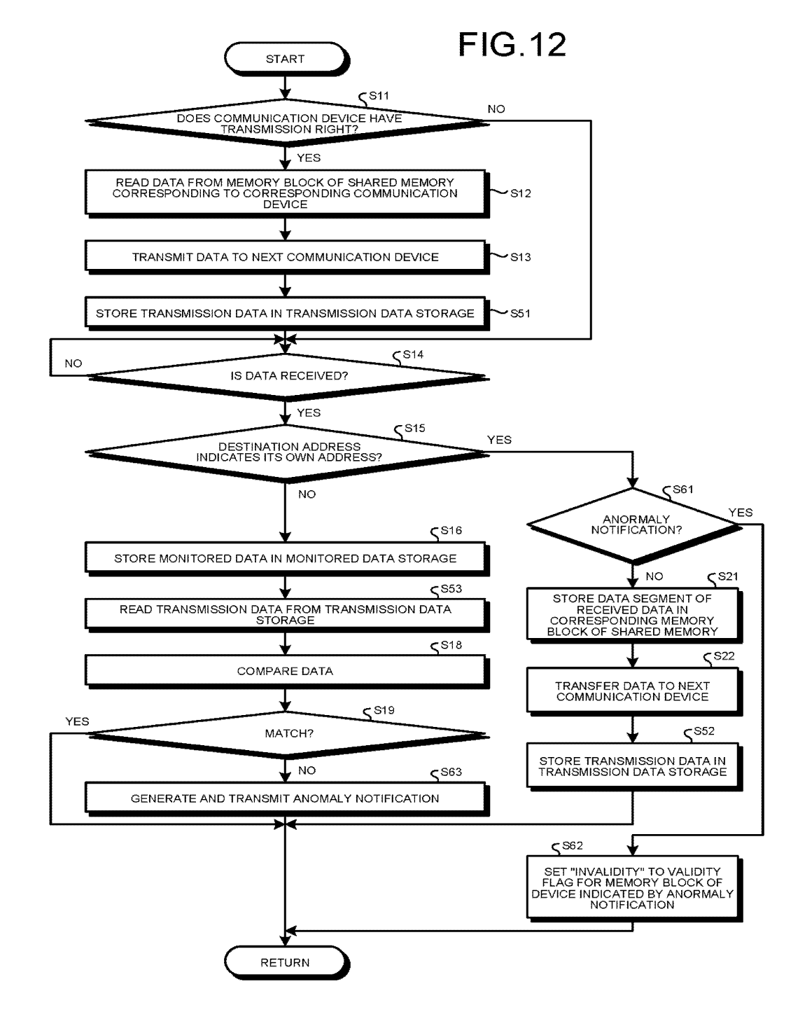

Next, the communication processing according to the present embodiment configured as mentioned above will be described. FIG. 12 is a flowchart of an example of the communication process in the third embodiment

The processing at steps S11 to S15 is performed in the same manner as in the second embodiment. When the destination of the received data matches the address of the corresponding communication device (the own device) (Yes at step S15), the wireless reception processor 23 determines whether or not the received data is the anomaly notifying message from the contents of the received data (step S61). When the received message is not the anomaly notifying message (No at step S61), the wireless reception processor 23 performs the same processing (steps S21, S22, and S52) as that in the second embodiment.

When the received data is the anomaly notifying message (Yes at step S61), the anomaly notification reception processor 113 sets “invalid” to the validity flag corresponding to the memory block indicated by the data identification number contained in the anomaly notifying message (step 62).

When the destination of the received data is not the address of the corresponding communication device (the own device) at step 315 (No at step 15), the wireless monitor 52 stores the received data as the monitored data in the monitored data storage 53 (step 316) and the data comparator 56 reads the temporarily stored transmission data from the transmission data storage 65 as the previously transmitted transmission data (step S53) to compare the data segment of the transmission data with the data segment of the monitored data (step 318), as in the second embodiment.

When both of them are identical to each other (Yes at step 319), the processing is finished. On the other hand, when both of them are not identical to each other (No at step 319), the anomaly notification transmission processor 103 generates and transmits the anomaly notifying message as described above (step S63).

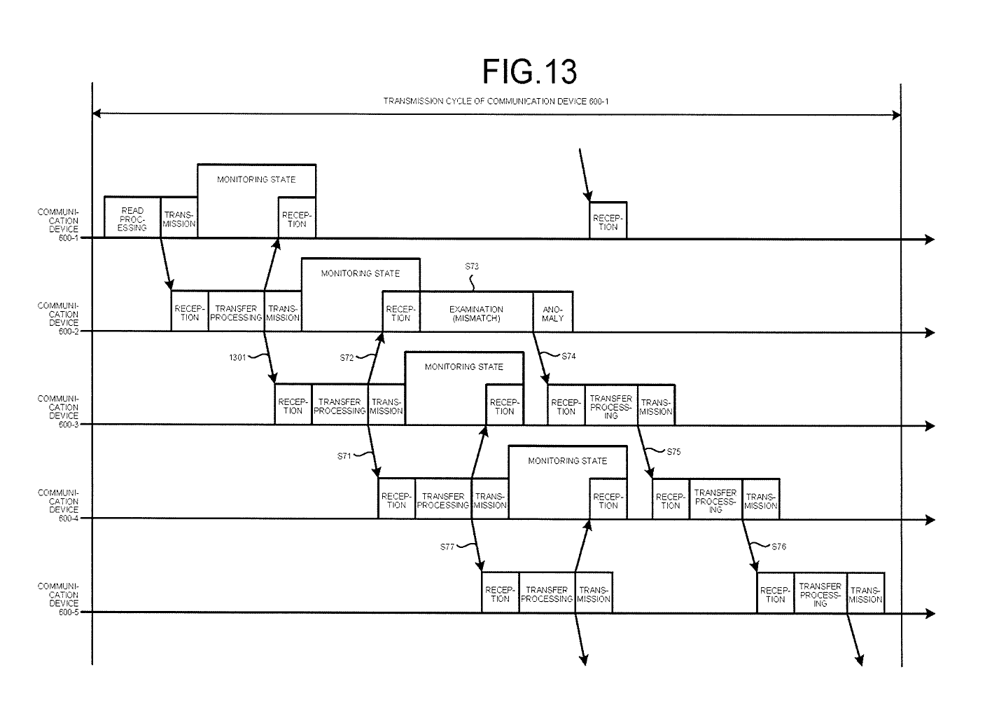

Next, an example of transmission and reception operations performed by executing the above-mentioned processing will be described. FIG. 13 is a time chart illustrating the example of the data transmission and reception operations in the third embodiment.

FIG. 13 illustrates an example in which error occurs in transmission data transmitted from the communication device 600-2 in a wireless communication zone 1301. The communication device 600-3 receives the data from the communication device 600-2 and transmits it to the communication device 600-4 (step S71). The data containing error is further transmitted to the communication device 600-5 at step S77. The communication device 600-2 in the monitoring state also receives the transmission data from the communication device 600-3 (step S72).

Having compared the temporarily stored, previous transmission data with the transmission data (monitored data) received from the communication device 600-3 and having detected a data mismatch (step S73), the communication device 600- generates and transmits an anomaly notifying message (step S74). The respective communication devices 600 perform transfer processing on the anomaly notifying message in the same manner as in that on normal data (steps 075 and 376). The anomaly notifying message is therefore transmitted to all of the communication devices 600 and they are notified of anomaly.

As described above, in the present embodiment, the communication device 600 transmits the anomaly notifying message when the transmission data (monitored data) acquired from the next communication device and the previous transmission data are not identical to each other. The communication device 600 identifies anomalous data and invalidates it when receiving the anomaly notifying message. According to the present embodiment all of the communication devices 600 in the network can receive the anomaly notification about occurrence of data containing error in the wireless communication zone and maintain data synchronism by excluding the erroneous data. With this configuration, the present embodiment can avoid system failure due to data error and improve the reliability of the fixed cycle operation.

Although the same wireless transmission path is used for transmission and reception of both the normal data and the anomaly notifying message in the present embodiment, the communication device 600 may be configured to change frequency channels for the normal data and the message.

Furthermore, although the transmission data temporarily stored in the transmission data storage 65 is used as the previous transmission data and compared with the transmission data (monitored data) acquired from the next communication device in the present embodiment, the transmission data should not be limited thereto. The data comparator 56 may be configured to read data from the memory block of the shared memory 25 corresponding to the communication device to which it belongs (the own device) and compare the read data with the monitored data.

### Fourth Embodiment

In a fourth embodiment, the communication device is configured to retransmit previous transmission data to the next communication device when transmission data (monitored data) acquired from the next communication device is not identical to the previous transmission data.

In the present embodiment, five communication devices 1400-1, 1400-2, 1400-3, 1400-4, and 1400-5 can wirelessly communicate with one another as illustrated in FIG. 1. The communication device 1400-1, 1400-2, 1400-3, 1400-4, and 1400-5 may be collectively referred to as a communication device 1400.

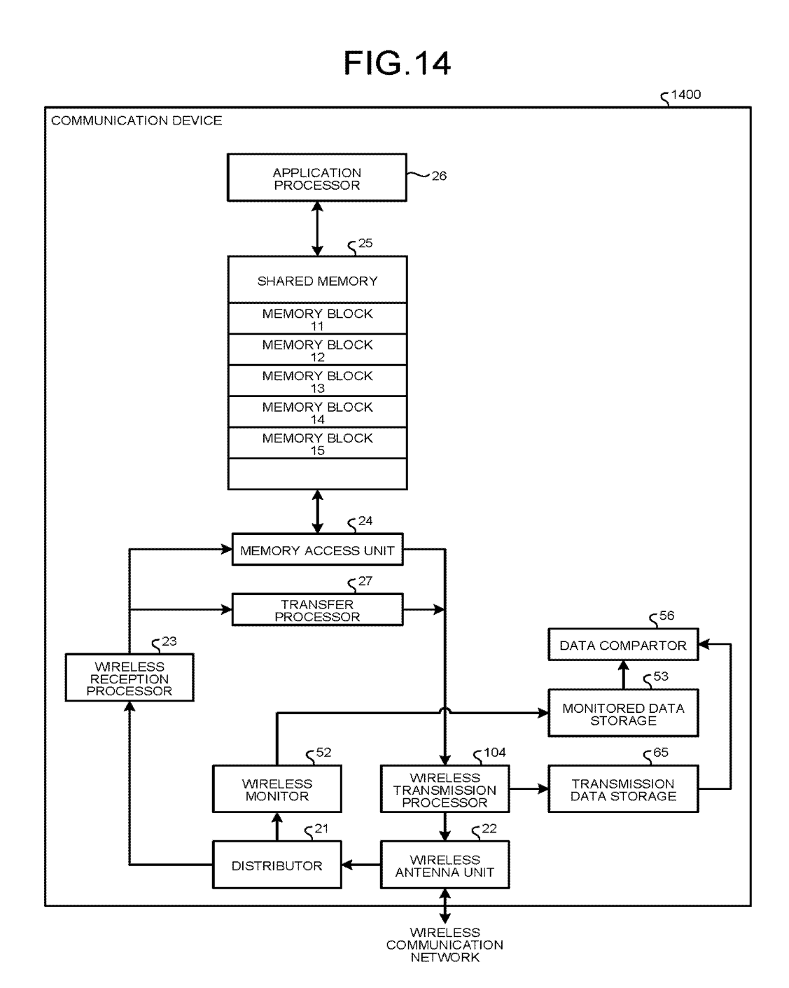

FIG. 14 is a block diagram illustrating the functional configuration of the communication device 1400 according to the fourth embodiment. As illustrated in FIG. 14, the communication device 1400 in the present embodiment includes the application processor 26, the shared memory 25, the memory access unit 24, the transfer processor 27, the wireless reception processor 23, the wireless monitor 52, the distributor 21, the wireless transmission processor 104, the wireless antenna unit 22, the data comparator 56, the monitored data storage 53, and the transmission data storage 65.

The functions of the application processor 26, the shared memory 25, the memory access unit 24, the transfer processor 27, the wireless reception processor 23, the wireless monitor 52, the distributor 21, the wireless antenna unit 22, the monitored data storage 53, and the transmission data storage 65 are the some as those in the second embodiment.

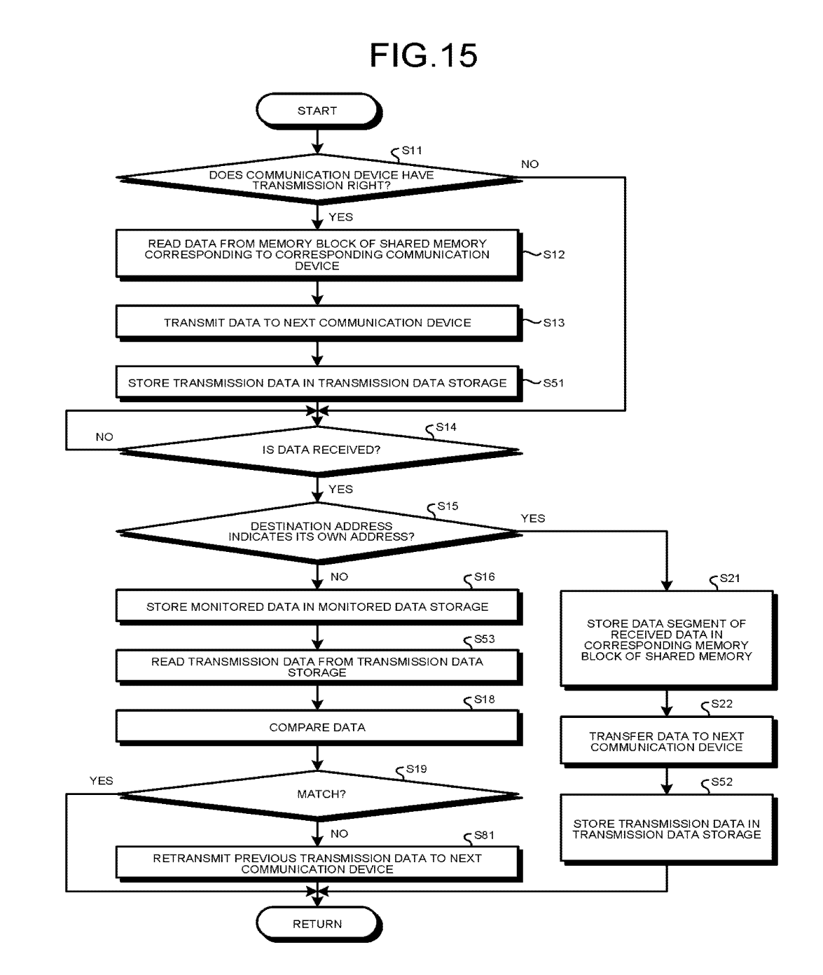

FIG. 15 is a flowchart of an example of communication process in the fourth embodiment.

The processing at steps S11 to S19 is performed in the same manner as in the second embodiment. The processing at steps S21, S22, and S52 is also performed in the same manner as in the second embodiment.

When the data comparator 56 determines that transmission data (monitored data) received from the next communication device 1400 in the monitoring state is not identical to transmission data (that is, transmission data previously transmitted to the next communication device 1400) temporarily stored in the transmission data storage 65 at step S19 (No at step S19), the wireless transmission processor 104 determines the monitored data as non-normal and retransmits the previously transmitted transmission data to the next communication device 1400 (step S81). To be specific, the wireless transmission processor 104 retransmits the transmission data temporarily stored in the transmission data storage 65 as the previously transmitted transmission data.

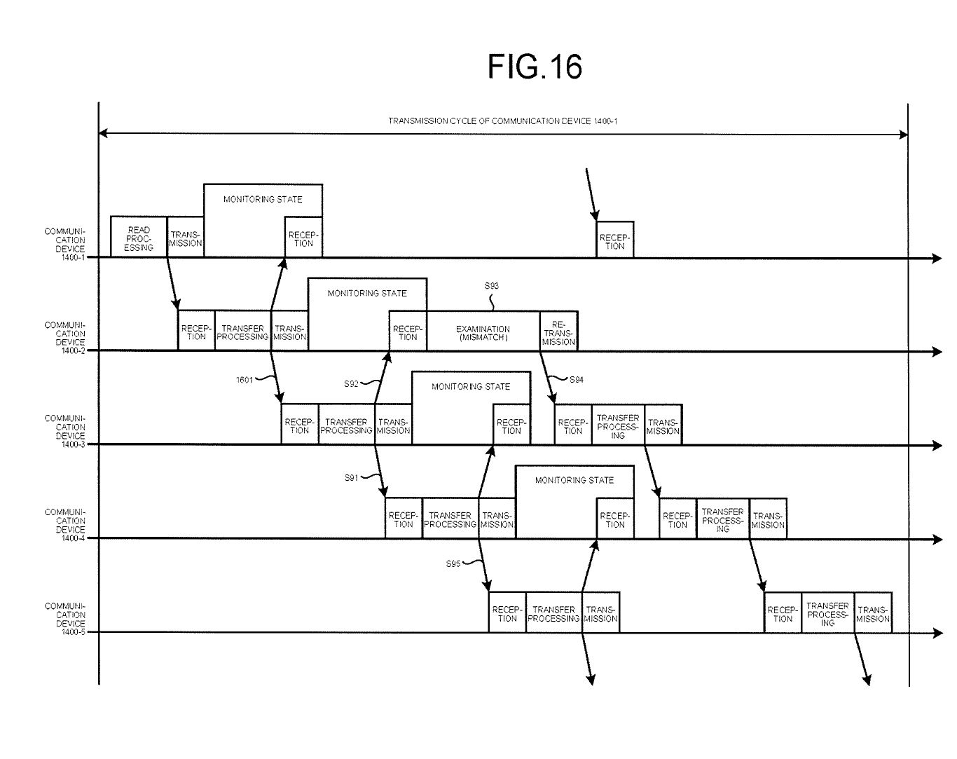

Next, an example of transmission and reception operations performed by executing the above-mentioned processing will be described. FIG. 16 is a time chart illustrating the example of the data transmission and reception operations in the fourth embodiment.

FIG. 16 illustrates an example in which error occurs in transmission data transmitted from the communication device 1400-2 in a wireless communication zone 1601. The communication device 1400-3 receives the data from the communication device 1400-2 and further transmits it to the communication device 1400-4 (step S91). The data containing error is also transmitted to the communication device 1400-5 at step S95. The communication device 1400-2 in the monitoring state also receives the transmission data from the communication device 1400-3 (step S92).

Upon comparing the temporarily stored, previous transmission data with the transmission data (monitored data) received from the communication device 1400-3 and detecting a data mismatch(step S93), the communication device 1400-2 retransmits the previous transmission data (the data transmitted in the zone 1601) (step S94).

As described above, in the present embodiment, the communication device 1400 retransmits the previous transmission data to the next communication device when the transmission data (monitored data) acquired from the next communication device and the previous transmission data are not identical to each other. The present embodiment can therefore reduce erroneous data by a simple retransmission procedure without transmission confirmation procedures defined by the protocol such as the TCP, avoid system failure due to data error, and improve the reliability of the fixed cycle operation.

Although the transmission data temporarily stored in the transmission data storage 65 is used as the previous transmission data to be retransmitted in the present embodiment, the transmission data should not be limited thereto. The wireless transmission processor 104 may be configured to read out data from the memory block of the shared memory 25 corresponding to the corresponding communication device (the own device) and retransmit the read data.

### Fifth Embodiment

In a fifth embodiment, the communication device broadcasts an anomaly notifying message through multicast transmission or the like when transmission data (monitored data) acquired from the next communication device and previous transmission data are not identical to each other.

The functional configuration of the communication device 600 in the present embodiment is the same as that in the third embodiment. The anomaly notification transmission processor 103 in the present embodiment generates the anomaly notifying message and broadcasts the generated anomaly notifying message to all of the communication devices 600 when the transmission data (monitored data) received from the next communication device 600 in the monitoring state is not identical to the transmission data previously transmitted to the next communication device 600. The data structure of the anomaly notifying message is the same as that in the third embodiment.

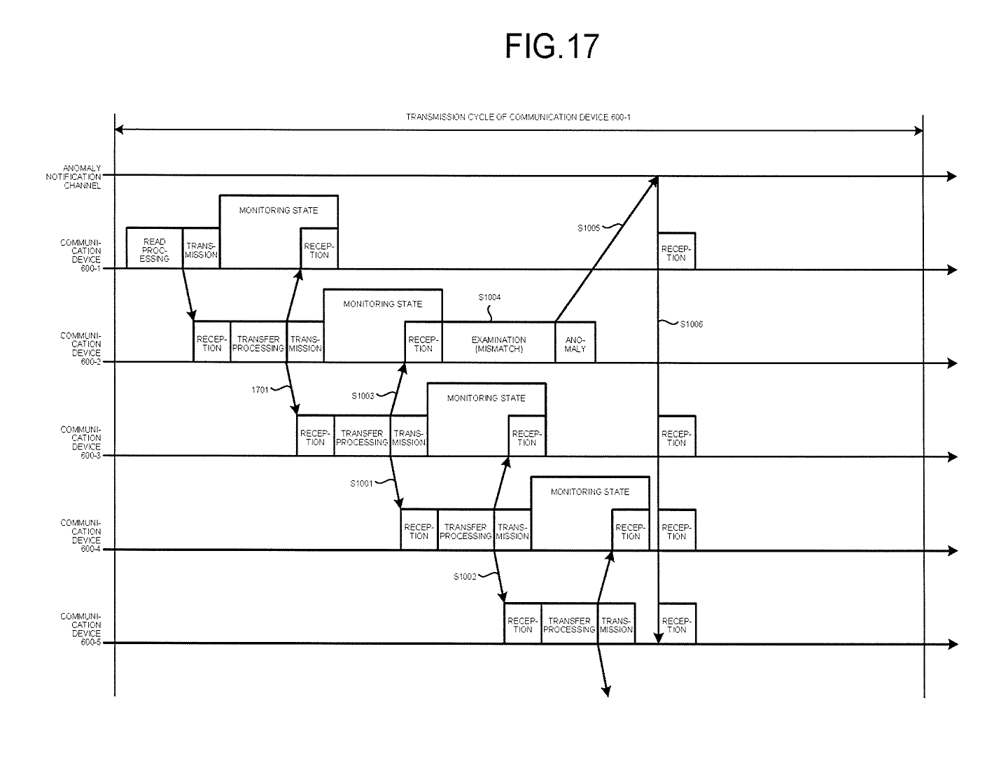

Next, an example of transmission and reception operations performed by executing the above-mentioned processing will be described. FIG. 17 is a time chart illustrating the example of the data transmission and reception operations in the fifth embodiment.

FIG. 17 illustrates an example in which error occurs in transmission data transmitted from the communication device 600-2 in a wireless communication zone 1701. The communication device 600-3 receives data from the communication device 600-2 and further transmits the data to the communication device 600-4 (step S1001). The data containing error is further transmitted to the communication device 600-5 at step S1002. The communication device 600-2 in the monitoring state also receives the transmission data from the communication device 600-3 (step S1003).

Upon comparing the temporarily stored, previous transmission data with the transmission data (monitored data) received from the communication device 600-3 and detecting a data mismatch (step S1004), the communication device 600-2 generates the anomaly notifying message and transmits it to an anomaly notification channel S1005). The anomaly notifying message is thereby broadcasted to all of the communication devices 600 through the anomaly notification channel (step 31006).

The anomaly notification channel represents anomaly notifying means that is common to the communication devices 600 and can reduce an information amount from that in normal data transmission. For this reason, the anomaly notification channel can be made of a long-distance, small-capacity wireless channel that differs from the wireless transmission system for normal data transmission, for example.

As described above, in the present embodiment, the communication device 600 broadcasts the anomaly notifying message to all of the communication devices 600 through the anomaly notification channel when the transmission data (monitored data) acquired from the next communication device and the previous transmission data are not identical to each other. In the present embodiment as in the third embodiment, the communication device 600 identifies anomalous data and invalidates it when receiving the anomaly notifying message. According to the present embodiment, all of the communication devices 600 in the network can therefore receive the anomaly notification about the occurrence of data which has contained error in the wireless communication zone and can maintain data synchronism by excluding the erroneous data. The present embodiment can thereby avoid system failure due to data error and improve the reliability of the fixed-cycle operation.

Although the above embodiments have exemplified the scan transmission system for a system in which the communication devices transmit data in turn through the wireless communication for data sharing, the system should not be limited thereto. Any system can be applied as long as data is transmitted through the wireless communication and shared by the communication devices.

The communication devices according to the above-mentioned embodiments include a control device such as a central processing unit (CPU), a storage device such as a read only memory (ROM) and a random access memory (R an external storage device such as a hard disk drive (HOD) and a compact disc (CD) drive device, a display device such as a display, and an input device such as a keyboard and has the hardware configuration including a common computer.

A communication program that is executed by the communication devices according to the above-mentioned embodiments is recorded in an installable or executable file format on a computer-readable recording medium such as a compact disc read only memory (CD-ROM), a flexible disk (FD), a compact disc recordable (CD-R), and a digital versatile disc (DVD) and provided as a computer program product.

The communication program that is executed by the communication devices according to the above-mentioned embodiments may be stored in a computer connected to a network such as the Internet and provided as a computer program product by being downloaded via the network. Furthermore, the communication program that is executed by the communication device according to the above-mentioned embodiments may be provided or distributed as a computer program product via a network such as the Internet.

The communication program that executed by the communication devices according to the above-mentioned embodiments may be pre-installed in a ROM, for example, and provided as a computer program product.

The communication program that is executed by the communication devices according to the above-mentioned embodiments has a module configuration including the above respective units (the application processor 26, the valid data selector 88, the memory access unit 24, the memory block reader 55, the transfer processor 27, the wireless reception processor 23, the wireless monitor 52, the distributor 21, the wireless transmission processor 28 or 104, the data comparator 56, the anomaly notification reception processor 113, and the anomaly notification transmission processor 103). By the CPU's (processor) reading and executing the communication program from the above-mentioned storage medium, the above respective units are loaded on the RAN to generate the application processor 26, the valid data selector 88, the memory access unit 24, the memory block reader 55, the transfer processor 27, the wireless reception processor 23, the wireless monitor 52, the distributor 21, the wireless transmission processor 28 or 104, the data comparator 56, the anomaly notification reception processor 113, and the anomaly notification transmission processor 103 on the described herein can be implemented as software applications, hardware and/or software modules, or components on one or more computers as a server. Although individually described, the various modules may share some or all of the same basic logic or codes.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A communication system comprising:
a plurality of communication devices that transmits shared data in turn through wireless communication, each of the communication devices comprising:
a shared memory that is capable of storing shared data for each of the communication devices;
a transmission processor that transmits the shared data of the communication device stored in the shared memory to a second communication device as another communication device;
a reception processor that monitors data as the shared data received by the second communication device from the communication device and transferred to a third communication device as another communication device other than the second communication device, and that receives the data as monitored data; and
a data comparator that compares the received monitored data with the data previously transmitted to the second communication device.

2. The communication system according to claim 1, wherein the data comparator compares the received monitored data with the shared data of the communication device stored in the shared memory as the data previously transmitted to the second communication device.

3. The communication system according to claim 1, wherein
each of the communication devices further includes a transmission data storage,
the transmission processor transmits the shared data to the second communication device and stores the transmitted data in the transmission data storage, and
the data comparator compares the received monitored data with the data stored in the transmission data storage as the data previously transmitted to the second communication device.

4. The communication system according to claim 1, wherein
each of the communication devices includes a storage that stores a validity flag for the shared data of each of the communication devices in the shared memory, the validity flag indicating validity of the shared data, and
the data comparator registers invalidity in the validity flag corresponding to the shared data corresponding to the second communication device having transmitted the monitored data, when the received monitored data is not identical to the data previously transmitted to the second communication device.

5. The communication system according to claim 1, wherein each of the communication devices includes an anomaly notification transmission processor that transmits an anomaly notification to the second communication device when the received monitored data is not identical to the data previously transmitted to the second communication device, the abnormality notification containing first identification information about the communication device having transmitted the monitored data and second identification information about the communication device having detected anomaly.

6. The communication system according to claim 5, wherein each of the communication devices includes:
a storage that stores a validity flag for shared data of each of the communication devices in the shared memory, the validity flag indicating validity of the shared data and
an anomaly notification reception processor that receives the anomaly notification, identifies, in the shared memory, the shared data corresponding to the communication device having transmitted the monitored data, based on the first identification information contained in the anomaly notification, and registers invalidity in the validity flag for the identified shared data.

7. The communication system according to claim 1, wherein the transmission processor retransmits, to the second communication device, the data previously transmitted to the second communication device when the received monitored data is not identical to the data previously transmitted to the second communication device.

8. The communication system according to claim 5, wherein the anomaly notification transmission processor broadcasts the anomaly notification to all of the communication devices when the received monitored data is not identical to the data previously transmitted to the second communication device.

9. A communication method comprising:
transmitting, to a second communication device as another communication device, shared data of a communication device stored in a shared memory capable of storing shared data of each of a plurality of communication devices that transmits the shared data in turn through wireless communication;
monitoring data as the shared data received by the second communication device from the communication device and transferred to a third communication device as another communication device other than the second communication device, and receiving the data as monitored data; and
comparing the received monitored data with the data previously transmitted to the second communication device.
